(19) United States
(12) Patent Application Publication
(10) Pub. No.: US 2023/0313344 A1
(43) Pub. Date: Oct. 5, 2023

(54) POWDER METAL MATERIAL FOR ADDITIVE MANUFACTURING WHICH IS ALUMINUM ALLOY AND ADDITIVE MANUFACTURING METHOD

(71) Applicant: HONDA MOTOR CO., LTD., Tokyo (JP)

(72) Inventors: Hiroyuki WATANABE, Saitama (JP); Kazuo KIKAWA, Saitama (JP); Masaki SHINKAWA, Saitama (JP)

(73) Assignee: HONDA MOTOR CO., LTD., Tokyo (JP)

(21) Appl. No.: 18/126,072

(22) Filed: Mar. 24, 2023

(30) Foreign Application Priority Data
Mar. 31, 2022 (JP) 2022-060256

(51) Int. Cl. C22C 21/02; B33Y 70/00; B22F 1/05; B33Y 10/00; B22F 10/28

(52) U.S. Cl. CPC C22C 21/02; B33Y 70/00; B22F 1/05; B33Y 10/00; B22F 10/28; B22F 2998/10; B22F 2999/00; B22F 2301/052; B22F 2304/10

(57) ABSTRACT

A powder metal material for additive manufacturing, which is an aluminum alloy, in which the powder metal material has an absorption rate of 65% or more determined by the following regression equation: Absorption rate (%)=23.5+1.9[Si]+7.4[Fe]−4.0[Cu]+109.6[Mn]+45.1[Mg]−14.5[Zn]−14.2[Ti]+2.6[Ni]−3.0[Zr]−218.1[Sc], where, [ ]represents a content (mass %) of each element.

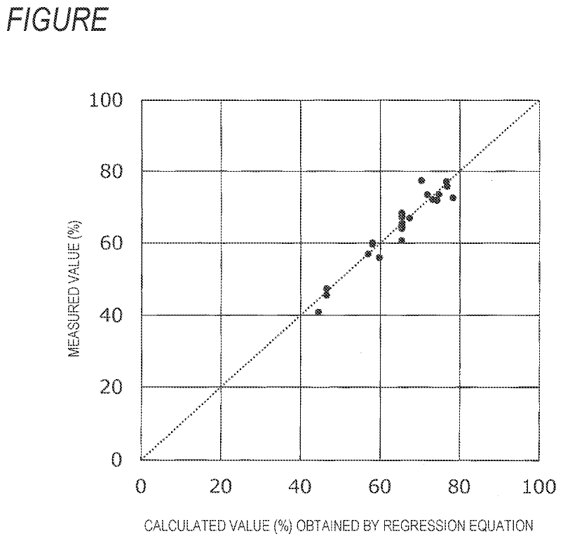

### CROSS-REFERENCE TO RELATED APPLICATION

This application is based on and claims priority under 35 USC 119 from Japanese Patent Application No. 2022-060256 filed on Mar. 31, 2022.

### TECHNICAL FIELD

The present invention relates to a powder metal material for additive manufacturing, which is an aluminum alloy and an additive manufacturing method.

### BACKGROUND ART

Aluminum alloys are used, for example, in applications requiring weight reduction, such as vehicles and aircraft.

An additive manufacturing method using an aluminum alloy powder is known (see, for example, JP2021-152189A).

### SUMMARY OF INVENTION

Aluminum alloy powders in the related art have been developed mainly for the purpose of improving mechanical properties of manufactured objects obtained by the additive manufacturing method.

However, for example, aluminum alloy powders in the related art such as Al10SiMg and AlMgSc have problems of a high laser reflectance and a slow manufacturing speed. From the viewpoint of energy efficiency, it is required to increase a laser absorption rate.

The present invention provides a powder metal material for additive manufacturing, which is an aluminum alloy having a high laser absorption rate, and an additive manufacturing method using the above powder metal material.

A powder metal material according to an aspect of the present invention is a powder metal material for additive manufacturing, which is an aluminum alloy, wherein the powder metal material has an absorption rate of 65% or more determined by the following regression equation.

Absorption rate (%)=23.5+1.9[Si]+7.4[Fe]−4.0[Cu]+109.6[Mn]+45.1[Mg]−14.5[Zn]−14.2[Ti]+2.6[Ni]−3.0[Zr]−218.1[Sc]

In the above equation, [ ] represents a content (mass %) of each element.

According to the present invention, it is possible to provide a powder metal material for additive manufacturing, which is an aluminum alloy having a high laser absorption rate, and an additive manufacturing method using the above powder metal material.

### BRIEF DESCRIPTION OF DRAWINGS

The FIGURE is a graph showing a relationship between a measured value and a calculated value obtained by a regression equation for an absorption rate of an aluminum alloy powder to laser (wavelength: 1081 nm).

### DETAILED DESCRIPTION OF THE INVENTION

Hereinafter, embodiments for carrying out the present invention will be described in detail.

### [Powder Metal Material]

A powder metal material according to the present invention is a powder metal material for additive manufacturing, which is an aluminum alloy, wherein the powder metal material has an absorption rate of 65% or more determined by the following regression equation.

Absorption rate (%)=23.5+1.9[Si]+7.4[Fe]−4.0[Cu]+109.6[Mn]+45.1[Mg]−14.5[Zn]−14.2[Ti]+2.6[Ni]−3.0[Zr]−218.1[Sc]

In the above equation, [ ] represents a content (mass %) of each element.

That is, [Si] represents a content (mass %) of Si in the powder metal material. [Fe] represents a content (mass %) of Fe in the powder metal material, [Cu] represents a content (mass %) of Cu in the powder metal material, [Mn] represents a content (mass %) of Mn in the powder metal material, [Mg] represents a content (mass %) of Mg in the powder metal material, [Zn] represents a content (mass %) of Zn in the powder metal material, [Ti] represents a content (mass %) of Ti in the powder metal material, [Ni] represents a content (mass %) of Ni in the powder metal material, [Zr] represents a content (mass %) of Zr in the powder metal material, and [Sc] represents a content (mass %) of Sc in the powder metal material.

The above regression equation is determined by multiple regression analysis. Specifically, the above regression equation is determined by preparing 21 types of aluminum alloy powders having different chemical compositions, actually measuring a laser absorption rate at a wavelength of 1081 nm, setting the content of contained atoms (mass %) as an explanatory variable, setting the laser absorption rate as a response variable, and performing multiple regression analysis.

The FIGURE is a graph showing a relationship between a measured value and a calculated value obtained by the above regression equation for an absorption rate of an aluminum alloy powder to laser (wavelength: 1081 nm).

As shown in the FIGURE, there is a small variation between the calculated value obtained by the regression equation and the actually measured value, and the accuracy of the regression equation is good.

The powder metal material according to the present invention has a high laser absorption rate, and when used for additive manufacturing (preferably for additive manufacturing using a 3D printer), the manufacturing speed is faster than that of the material in the related art, and the productivity and the energy efficiency are excellent.

The absorption rate of the powder metal material according to the present invention determined by the above regression equation is preferably 70% or more.

The absorption rate of the powder metal material according to the present invention determined by the above regression equation may be 90% or less, or 85% or less.

It is preferable that the aluminum alloy of the powder metal material according to the present invention contains, in terms of mass %,
Ti: 0.1% to 3.0%.
Zr: 3.0% or less,
Si: 3.0% to 20.0%.
Cu: 0.1% to 10.0%,
Mn: 1.0% or less,
Mg: 0.1% to 3.0%,
Ni: 3.0% or less,
Cr: 0.5% or less,
Zn: 0.05% to 3.0%,
Fe: 0.1% to 5.0%, and
Sc: 3.0% or less.

Note that unless otherwise specified, the content of each alloying element is a mass-based value based on 100% of the entire aluminum alloy.

When the powder metal material according to the present invention positively contains the above impurity elements in addition to Al, which is the main constituent element of the aluminum alloy, the specific resistance can be increased and the laser absorption rate can be increased. Since the powder metal material according to the present invention may positively contain impurity elements, it is preferred from the viewpoint that secondary ingots containing many impurities such as Fe and Zn, or recycled materials containing many impurities can be used as raw materials and from the viewpoint of reducing carbon dioxide emissions during production, saving resources, and reducing environmental load.

The aluminum alloy of the powder metal material according to the present invention preferably has the balance being Al and inevitable impurities in the above chemical composition.

In the aluminum alloy of the powder metal material according to the present invention, a content of Al is preferably 60 mass % or more, more preferably 70 mass % or more, and still more preferably 80 mass % or more.

The inevitable impurities are components that can be inevitably mixed from raw materials or the environment during the production of the aluminum alloy in the present invention. A content of the inevitable impurities is usually 2 mass % or less.

A content of Ti in the aluminum alloy is preferably 0.1 mass % to 3.0 mass %, more preferably 0.5 mass % to 2.5 mass %, and still more preferably 1.0 mass % to 2.0 mass %.

A content of Zr in the aluminum alloy is preferably 3.0 mass % or less, more preferably 2.0 mass % or less, and still more preferably 1.5 mass % or less. The lower limit of the content of Zr in the aluminum alloy is not particularly limited, and may be 0 mass % or more. The aluminum alloy may not contain Zr. When the aluminum alloy contains Zr, the content of Zr may be 0.7 mass % to 2.5 mass % or 1.0 mass % to 1.3 mass %.

A content of Si in the aluminum alloy is preferably 3.0 mass % to 20.0 mass %, more preferably 5.0 mass % to 17.0 mass %, and still more preferably 8.0 mass % to 15.0 mass %.

A content of Cu in the aluminum alloy is preferably 0.1 mass % to 10.0 mass %, more preferably 1.0 mass % to 7.0 mass %, and still more preferably 3.0 mass % to 5.0 mass %.

A content of Mn in the aluminum alloy is preferably 1.0 mass % or less, more preferably 0.03 mass % to 0.8 mass %, and still more preferably 0.1 mass % to 0.5 mass %.

A content of Mg in the aluminum alloy is preferably 0.1 mass % to 3.0 mass %, more preferably 0.2 mass % to 2.0 mass %, and still more preferably 0.3 mass % to 1.0 mass %.

A content of Ni in the aluminum alloy is preferably 3.0 mass % or less, more preferably 2.0 mass % or less, and still more preferably 1.5 mass % or less. The lower limit of the content of Ni in the aluminum alloy is not particularly limited, and may be 0 mass % or more. The aluminum alloy may not contain Ni. When the aluminum alloy contains Ni, the content of Ni may be 0.1 mass % to 2.5 mass % or 0.5 mass % to 1.0 mass %.

A content of Cr in the aluminum alloy is preferably 0.5 mass % or less, more preferably 0.3 mass % or less, and still more preferably 0.1 mass % or less. The lower limit of the content of Cr in the aluminum alloy is not particularly limited, and may be 0 mass % or more. The aluminum alloy may not contain Cr. When the aluminum alloy contains Cr, the content of Cr may be 0.01 mass % to 0.2 mass % or 0.03 mass % to 0.1 mass %.

A content of Zn in the aluminum alloy is preferably 0.05 mass % to 3.0 mass %, more preferably 0.1 mass % to 2.0 mass %, and still more preferably 0.2 mass % to 1.0 mass %.

A content of Fe in the aluminum alloy is preferably 0.1 mass % to 5.0 mass %, more preferably 0.5 mass % to 3.0 mass %, and still more preferably 1.0 mass % to 2.0 mass %.

A content of Sc in the aluminum alloy is preferably 3.0 mass % or less, more preferably 2.0 mass % or less, and still more preferably 1.0 mass % or less. The lower limit of the content of Sc in the aluminum alloy is not particularly limited, and may be 0 mass % or more. The aluminum alloy may not contain Sc.

The particle size of the powder metal material according to the present invention is not particularly limited. Known particle sizes suitable for additive manufacturing (for example, 10 μm to 200 μm of volume average particle size (D₅₀) measured with a laser diffraction particle size distribution measuring device) can be used.

A method for producing the powder metal material according to the present invention is not particularly limited, and known methods (for example, a gas atomization method, a plasma atomization method, and a centrifugal atomization method) can be used.

### [Additive Manufacturing Method]

In an additive manufacturing method according to the present invention, it is preferable to use the above powder metal material, and it is particularly preferable to use the above powder metal material in manufacturing using a 3D printer.

The additive manufacturing method according to the present invention is faster in manufacturing speed than that in an additive manufacturing method of metal powder in the related art, and has excellent productivity and excellent energy efficiency.

As the 3D printer, a known one can be used.

The additive manufacturing method is not particularly limited, and for example, a powder bed fusion method and a direct energy deposition method are preferred.

The manufactured object produced by the additive manufacturing method according to the present invention can be used for various purposes such as automobile parts.

### EXAMPLES

Hereinafter, the present invention will be described more specifically by way of Examples and Comparative Examples, but the present invention is not limited thereto.

An aluminum alloy powder (average particle size: 40 μm) having the composition shown in Table 1 below was irradiated with laser having a wavelength of 1081 nm, and the laser absorption rate was measured and determined with a spectrophotometer manufactured by Hitachi High-Tech Corporation. In Table 1, “Bal” indicates “balance”.

As the aluminum alloy powder in Comparative Example 1 and Comparative Example 2, a commercially available powder was used.

Table 1 shows measurement results (actually measured values) of the absorption rate.

TABLE 1

| | | | | | | | | | | | | | Absorption |
|---|---|---|---|---|---|---|---|---|---|---|---|---|---|
| mass % | Si | Cu | Mn | Mg | Zn | Fe | Ni | Cr | Zr | Ti | Sc | Al | rate (%) |
| Comparative | 10 | — | — | 0.4 | — | 0.15 | — | — | — | — | — | Bal | 63 |
| Example 1 | | | | | | | | | | | | | |
| (Al10SiMg) | | | | | | | | | | | | | |
| Comparative | — | — | — | 4 | — | — | — | — | 0.2 | — | 0.7 | Bal | 45 |
| Example 2 | | | | | | | | | | | | | |
| (AlMgSc) | | | | | | | | | | | | | |
| Example 1 | 12.8 | 4.5 | 0.1 | 0.7 | 0.25 | 1.2 | 0.9 | 0.04 | — | 0.15 | — | Bal | 77 |
| Example 2 | 12.8 | 4.5 | 0.1 | 0.7 | 0.25 | 0.15 | 0.9 | 0.04 | — | 0.15 | — | Bal | 71 |
| Example 3 | 12.2 | 3.8 | 0.4 | 0.4 | 0.8 | 1.0 | — | — | 1.26 | 1.0 | — | Bal | 73 |
| Example 4 | 12.2 | 3.8 | 0.4 | 0.4 | 0.8 | 1.0 | — | — | — | 1.0 | — | Bal | 73 |

As can seen from Table 1, the laser absorption rate of the aluminum alloy powders in Examples 1 to 4 is higher than the laser absorption rate of the aluminum alloy powders in Comparative Examples 1 and 2.

According to the present invention, the laser absorption rate of the powder metal material for additive manufacturing can be higher than that of the material in the related art, so that the manufacturing speed is faster, and cost reduction and carbon dioxide reduction can be expected.

Although the embodiment of the present invention has been described above, the present invention is not limited to the above embodiment, and modifications, improvements, or the like can be made as appropriate.

In the present description, at least the following matters are described.

(1) A powder metal material for additive manufacturing, which is an aluminum alloy, wherein the powder metal material has an absorption rate of 65% or more determined by the following regression equation:

Absorption rate (%)=23.5+1.9[Si]+7.4[Fe]−4.0[Cu]+109.6[Mn]+45.1[Mg]−14.5[Zn]−14.2[Ti]+2.6[Ni]−3.0[Zr]−218.1[Sc]

in the above equation, [ ] represents a content (mass %) of each element.

According to (1), the powder metal material has a high laser absorption rate, and when used for additive manufacturing (preferably for additive manufacturing using a 3D printer), the manufacturing speed is faster than that of the material in the related art, and the productivity and the energy efficiency are excellent.

(2) The powder metal material according to (1), in which the aluminum alloy contains in terms of mass %.
Ti: 0.1% to 3.0%,
Zr: 3.0% or less,
Si: 3.0% to 20.0%,
Cu: 0.1% to 10.0%.
Mn: 1.0% or less,
Mg: 0.1% to 3.0%,
Ni: 3.0% or less,
Cr: 0.5% or less,
Zn: 0.05% to 3.0%,
Fe: 0.1% to 5.0%, and
Sc: 3.0% or less.

According to (2), when the powder metal material positively contains the above impurity elements in addition to Al, which is the main constituent element of the aluminum alloy, the specific resistance can be increased and the laser absorption rate can be increased. In addition, since impurity elements may be positively contained, it is preferred from the viewpoint that secondary ingots containing many impurities such as Fe and Zn, or recycled materials containing many impurities can be used as raw materials and from the viewpoint of reducing carbon dioxide emissions during production, saving resources, and reducing environmental load.

(3) An additive manufacturing method including:
performing manufacturing using a 3D printer by using the powder metal material according to (1) or (2).

According to (3), the manufacturing speed is faster than that of the material in the related art, and the productivity and the energy efficiency are excellent.

What is claimed is:

1. A powder metal material for additive manufacturing, which is an aluminum alloy, wherein the powder metal material has an absorption rate of 65% or more determined by the following regression equation:
Absorption rate (%)=23.5+1.9[Si]+7.4[Fe]−4.0[Cu]+109.6[Mn]+45.1[Mg]−14.5[Zn]−14.2[Ti]+2.6[Ni]−3.0[Zr]−218.1[Sc]
where, [ ] represents a content (mass %) of each element.

2. The powder metal material according to claim 1, wherein
the aluminum alloy contains
0.1 to 3.0 mass % of Ti,
3.0 mass % or less of Zr,
3.0 to 20.0 mass % of Si,
0.1 to 10.0 mass % of Cu,
1.0 mass % or less of Mn,
0.1 to 3.0 mass % of Mg,
3.0 mass % or less of Ni,
0.5 mass % or less of Cr,
0.05 to 3.0 mass % of Zn,
0.1 to 5.0 mass % of Fe, and
3.0 mass % or less of Sc.

3. An additive manufacturing method comprising:
performing manufacturing using a 3D printer by using the powder metal material according to claim 1.

4. An additive manufacturing method comprising;
performing manufacturing using a 3D printer by using the powder metal material according to claim 2.
